(19) United States
(12) Patent Application Publication
(10) Pub. No.: US 2023/0265715 A1
(43) Pub. Date: Aug. 24, 2023

(54) Ladder lateral stabilizer accessory

(71) Applicant: Louis Laperriere, Dunham (CA)

(72) Inventor: Louis Laperriere, Dunham (CA)

(21) Appl. No.: 17/986,412

(22) Filed: Nov. 14, 2022

(30) Foreign Application Priority Data
Feb. 24, 2022 (GB) 2202593.6

(51) Int. Cl. E06C 7/42

(52) U.S. Cl. CPC E06C 7/423

(57) ABSTRACT

A ladder lateral stabilizer accessory is provided, which includes a pair of stabilizing members, one for each side of a ladder. Each stabilizing member is attached to the side runners of a ladder by way of filleted rod running through the rungs such that they connect the pair of stabilizing members together from across the width of the ladder. Once installed, the upper part of the pair of stabilizing members which is hingedly attached to the lower part of the stabilizing members. Each movable member of the stabilizing members pivots downwardly so as to make contact with the ground, including uneven ground. When not in use, the upper parts are releasably attached to the ladder runners by way of wing nuts.

### CROSS-REFERENCE TO RELATED APPLICATIONS

The present application claims priority to application number GB2202593.6, filed on Feb. 22, 2022, the disclosure of which is hereby incorporated in its entirety at least by reference.

### BACKGROUND OF THE INVENTION

### 1. Field of the Invention

The present invention relates to ladder accessories but more particularly to a ladder lateral stabilizer accessory.

### 2. Description of Related Art

There is a persistent problem with ladder stability. Numerous inventions and improvised devices have been made over the years, each tackling this persistent problem from a different perspective. The various inventions show extension members which are pivotally attached at some point along the length of the ladder and splay downwardly from there so as to create an “A” frame, thus increasing stability. Some of those extensions are telescopic to further increase adjustability on uneven grounds. However, there is still room for a low cost, secure, reliable, and simple accessory that can stabilize a ladder on uneven ground.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

In one aspect of the invention, a ladder lateral stabilizer accessory is provided, comprising a pair of stabilizing members, wherein each stabilizing member of the pair of stabilizing members is attached to a side rail of a ladder, wherein the ladder includes rungs across a width of the ladder; the pair of stabilizing members each comprising a movable section and a fixed section, wherein the movable section pivotally attached to the fixed section via a hinge; and, wherein the movable section is configured to pivot downwardly to make contact with a ground surface.

In one embodiment, each fixed section is attached to the side rail of the ladder by way of a filleted rod running through the rungs and mechanically fastened by way of mechanical fasteners such that they connect the pair of stabilizing members together from across the width of the ladder. In one embodiment, the ground surface is level. In another embodiment, the ground surface is uneven. In one embodiment, the movable section has an end capped with a pivoting pad. In one embodiment, the movable section is releasably attached to the side rail via wing nuts. In one embodiment, the movable section is fixed in length. In another embodiment, the movable section is configured to pivot downwardly at varying angles to make contact with uneven ground surface. In one embodiment, the movable section is longer than the fixed section

The foregoing has outlined rather broadly the more pertinent and important features of the present disclosure so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is an exploded view of the invention for installation with a ladder according to an embodiment of the present invention.

FIG. 2A is a perspective view of the invention installed on the ladder according to an embodiment of the invention.

FIG. 2B is a detailed perspective view of the invention installed on the ladder according to an embodiment of the invention.

FIG. 3A shows a front view of the invention installed on the ladder according to an embodiment of the invention.

FIG. 3B shows a front view of the invention in use on even ground according to an embodiment of the invention.

FIG. 3C shows a front view of the invention in use on uneven ground according to an embodiment of the invention.

### DETAILED DESCRIPTION OF THE PREFERRED EMBODIMENT

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein to specifically provide a ladder lateral stabilizer accessory.

It is to be understood that the terminology used herein is for the purpose of describing particular embodiments only and is not intended to be limiting. The terms “a” or “an,” as used herein, are defined as to mean “at least one”. The term “plurality,” as used herein, is defined as two or more. The term “another,” as used herein, is defined as at least a second or more. The terms “including” and/or “having,” as used herein, are defined as comprising (i.e., open language). The term “coupled,” as used herein, is defined as connected, although not necessarily directly, not necessarily mechanically, and not permanent. The term “providing” is defined herein in its broadest sense, e.g., bringing/coming into physical existence, making available, and/or supplying to someone or something, in whole or in multiple parts at once or over a period of time. As used herein, the terms “about”, “generally”, or “approximately” apply to all numeric values, whether or not explicitly indicated. These terms generally refer to a range of numbers that one of skill in the art would consider near the stated amount by about 0%, 5%, or 10%, including increments therein. In many instances these terms may include numbers that are rounded to the nearest significant figure.

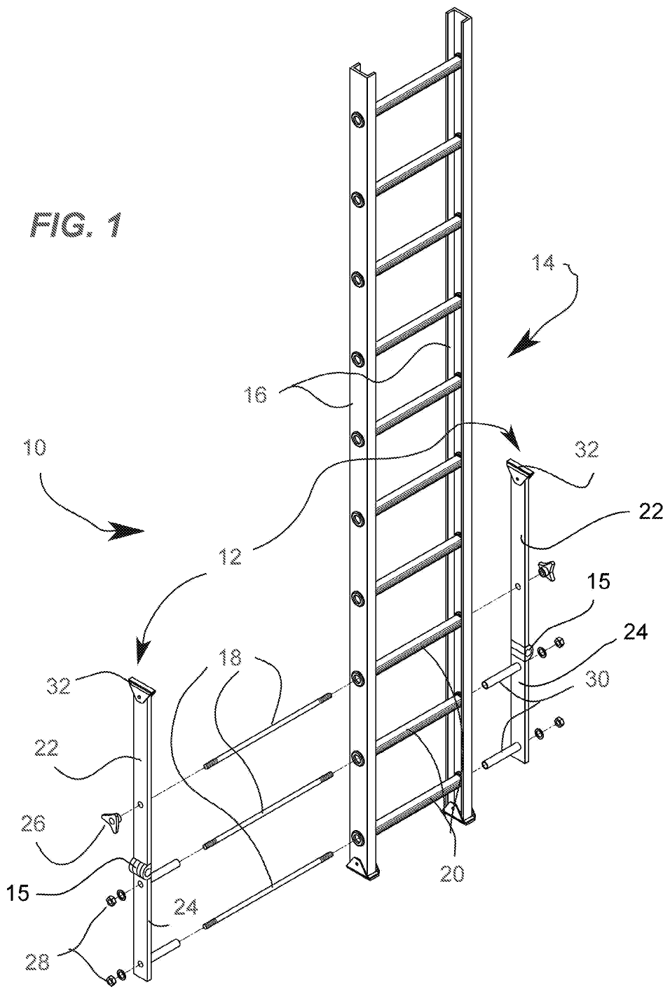

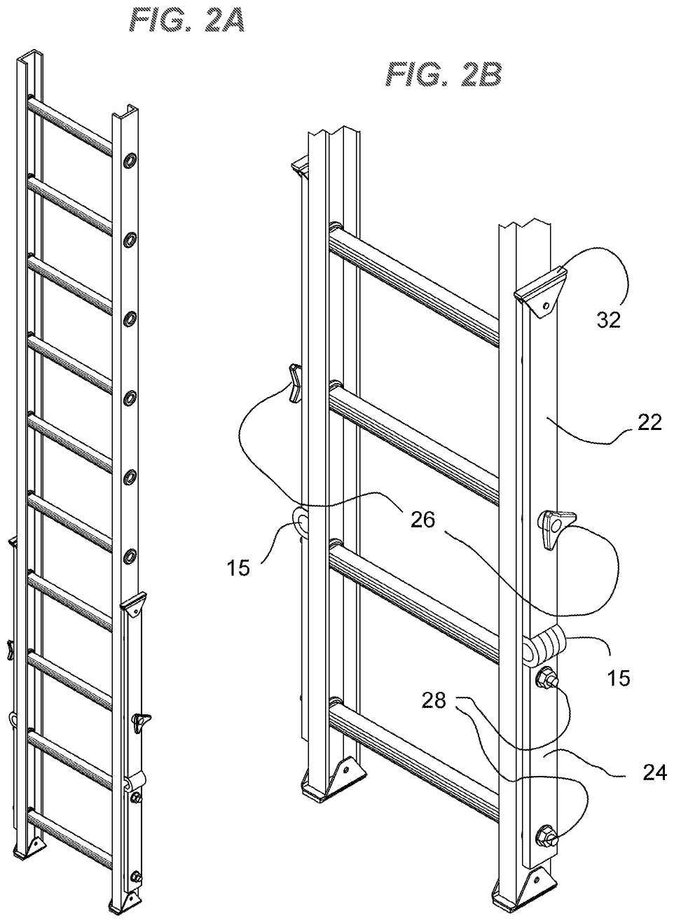

Referring now to FIGS. 1 and FIGS. 2A and B, a ladder lateral stabilizer accessory 10 is illustrated. In one embodiment, the ladder lateral stabilizer accessory 10 comprising a pair of stabilizing members 12, wherein stabilizing member is provided for each side of a ladder 14. In some embodiments, the pair of stabilizing members 12 are each subdivided into two sections 22 and 24, wherein the two sections include a movable section 22 pivotally attached to a fixed section 24 by way of a hinge 15. In some embodiments, the fixed section 24 is fixedly attached to the side runners or side rails 16 of the ladder 14 by way of filleted rods 18 running through the rungs 20 and mechanically fastened by way of mechanical fasteners 28. It should be understood, that the mechanical fasteners 28 can be selected from but not limited to the group comprising nuts and bolts and rivets. With the use of filleted rods 18, each stabilizing member of the pair of stabilizing members 12 are connected from across the width of the ladder 14, which increases the securing of the lateral stabilizer accessory 10 to the ladder 14. Moreover, for a tighter hold inside the rungs 20, short pipe sections 30 are inserted through the rungs with the filleted rods 18 inserted therein.

In some embodiments, the movable sections 22 of the ladder lateral stabilizer accessory 10 have their ends capped with pivoting pads 32. The pivoting pads may include any known pivoting pad well known in the art of ladders. For instance, the pivoting pads may include built-in spikes that can be planted in the ground by pivoting the pad upwardly so as to present the spike downwardly for insertion in the soil. When not in use, the movable sections 22 are releasably attached to the ladder runners 16 by way of wing nuts 26.

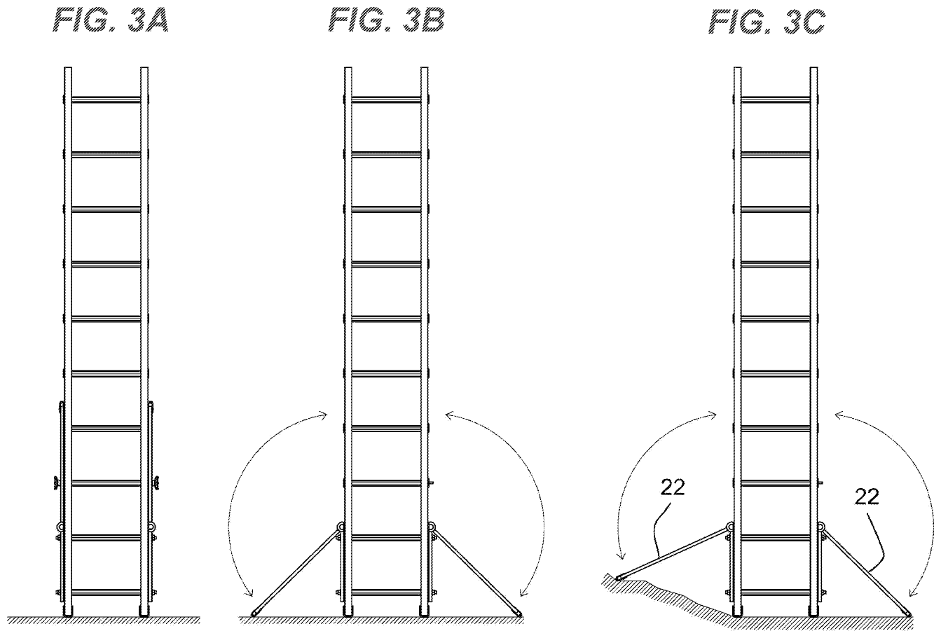

During use, as best seen in FIGS. 3A-C, the movable section 22 pivots downwardly so as to make contact with the ground on both even and uneven ground. The advantage of having the movable sections 22 pivot laterally in a downward fashion as opposed to pivoting laterally upwardly as seen in some of the prior art is that there is no need for the movable sections 22 to be telescopic in order to adjust to uneven ground, as seen in FIG. 3C. Simply varying their angles adjusts for the unevenness, without the requirement for adjusting length. Advantageously, the movable sections 22 of the present invention are fixed in length, reducing material cost, improving efficiency, while extending the durability and life of the product as telescoping members tend to be fragile and subject to stress forces between each telescoping member which may compromise the integrity and stability of the ladder stabilizing system. Also, by being substantially longer than the fixed sections 24, the movable sections 22 can pivot closer to the ground and their lengths only requires a few degrees of variations in order to ensure proper leveling. It should be understood that the overall length of the ladder lateral stabilizer accessory, and more specifically the fixed sections 24 and movable sections 22 may vary, however, as previously mentioned, the movable sections 22 are required to be substantially longer than the fixed sections 24.

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

What is claimed is:

1. A ladder lateral stabilizer accessory comprising:
a pair of stabilizing members, wherein each stabilizing member of the pair of stabilizing members is attached to a side rail of a ladder, wherein the ladder includes rungs across a width of the ladder;
the pair of stabilizing members each comprising a movable section and a fixed section, wherein the movable section pivotally attached to the fixed section via a hinge; and,
wherein the movable section is configured to pivot downwardly to make contact with a ground surface.

2. The ladder lateral stabilizer accessory of claim 1, wherein each fixed section is attached to the side rail of the ladder by way of a filleted rod running through the rungs and mechanically fastened by way of mechanical fasteners such that they connect the pair of stabilizing members together from across the width of the ladder.

3. The ladder lateral stabilizer accessory of claim 1, wherein the ground surface is level.

4. The ladder lateral stabilizer accessory of claim 1, wherein the ground surface is uneven.

5. The ladder lateral stabilizer accessory of claim 1, wherein the movable section has an end capped with a pivoting pad.

6. The ladder lateral stabilizer accessory of claim 1, wherein the movable section is releasably attached to the side rail via wing nuts.

7. The ladder lateral stabilizer accessory of claim 1, wherein the movable section is fixed in length.

8. The ladder lateral stabilizer accessory of claim 4, wherein the movable section is configured to pivot downwardly at varying angles to make contact with uneven ground surface.

9. The ladder lateral stabilizer accessory of claim 1, wherein the movable section is longer than the fixed section.
